(19) United States
(12) Patent Application Publication
(10) Pub. No.: US 2017/0141668 A1
(43) Pub. Date: May 18, 2017

(54) CHIP-SCALE ELECTROMAGNETIC VIBRATIONAL ENERGY HARVESTER

(71) Applicant: Analog Devices, Inc., Norwood, MA (US)

(72) Inventors: Xing Xing, San Jose, CA (US); Baoxing Chen, Westford, MA (US)

(73) Assignee: Analog Devices, Inc., Norwood, MA (US)

(21) Appl. No.: 15/147,306

(22) Filed: May 5, 2016

Related U.S. Application Data
(60) Provisional application No. 62/254,786, filed on Nov. 13, 2015.

(51) Int. Cl. H02K 35/06; H02K 11/00; H02K 7/18; H02K 11/04; H02K 1/34; H02K 3/46

(52) U.S. Cl. CPC H02K 35/06; H02K 1/34; H02K 3/46; H02K 7/1876; H02K 11/046; H02K 11/0094

(57) ABSTRACT

A chip-scale vibrational energy harvester circuit may include magnets and coils with magnetic cores provided in proximity thereto. Either the magnets or the coils may be mounted on a micro-electromechanical spring system (MEMS) that is coupled to a stationary frame. The counterpart component may be mounted on the stationary frame. When the stationary frame experiences vibrational activity, the magnets and the coils may move with respect to each other, causing variations in the flux passing through the coils. The variations in the flux may induce voltages across the coils. The induced voltages may be rectified and stored as energy for later use.

### CROSS REFERENCE TO RELATED APPLICATIONS

This application claims the benefit under 35 U.S.C. §119(e) of U.S. Provisional Application Ser. No. 62/254,786 titled “Chip Scale Electromagnetic Vibrational Harvester” filed on Nov. 13, 2015, which is hereby incorporated herein by reference in its entirety.

### BACKGROUND

The demand for energy harvesting devices has been growing rapidly with the wide application of mobile electronics and wireless sensors. Mechanical energy associated with vibration has been one of the major energy sources for energy harvesting systems. Different vibrational energy harvesting mechanisms have been utilized, including electromagnetic, electrostatic, piezoelectric, and magnetoelectric (ME) mechanisms. Generally speaking, these prior designs suffer from weak energy density and magnetic coupling, which reduce their performance. Moreover, many such designs are not suited to chip-scale applications that are necessary for many commercial applications.

An electromagnetic vibrational energy harvester is a device that converts vibrational energy from the surface on which it is mounted to electrical energy that can be utilized by other electronics. However, state-of-the-art vibrational energy harvesters have severe bandwidth limitations, inhibiting peak power output from being achieved.

### SUMMARY

In certain embodiments of the present disclosure, an apparatus is provided that discloses a coil system, a magnet system defining a magnetic flux, and a micro-electromechanical spring system (MEMS spring). In response to vibrational energy, the MEMS spring may change a relative position between the coil system and the magnet system such that, at a first position, the magnetic flux is oriented in a first direction through the coil system and, at a second position, the magnetic flux is oriented in a second direction through the coil system.

In certain embodiments of the present disclosure, a method is provided that discloses providing a magnetic flux via a magnet system and changing, in response to vibrational energy, a relative position between a coil system and the magnet system using a MEMS spring, such that, at a first position, the magnetic flux is oriented in a first direction through the coil system and, at a second position, the magnetic flux is oriented in a second direction through the coil system

In certain embodiments of the present disclosure, a system is provided that discloses an energy harvester, a storage circuit, and a rectifier circuit coupling the energy harvester to the storage circuit. The energy harvester includes a coil system, a magnet system defining a magnetic flux, and a micro-electromechanical spring system (MEMS spring). In response to vibrational energy, the MEMS spring may change a relative position between the coil system and the magnet system such that, at a first position, the magnetic flux is oriented in a first direction through the coil system and, at a second position, the magnetic flux is oriented in a second direction through the coil system. The rectifier circuit rectifies an alternating current from the coil system and stores energy from the coil system in the storage circuit.

### BRIEF DESCRIPTION OF THE DRAWINGS

FIG. 1 illustrates a vibrational energy harvester according to an embodiment of the present disclosure.

FIGS. 2A-2C illustrate sectional views of the vibrational energy harvester of FIG. 1.

FIG. 3 depicts a block diagram of an energy harvester circuit system according to an embodiment of the present disclosure.

FIGS. 4A-4C illustrate exemplary waveforms according to an embodiment of the present disclosure.

FIG. 5 illustrates a vibrational energy harvester according to an embodiment of the present disclosure.

FIGS. 6A-6C illustrate sectional views of the vibrational energy harvester of FIG. 5.

FIG. 7 illustrates a sectional view of a coil with a magnetic core according to an embodiment of the present disclosure.

FIG. 8A illustrates a vibrational energy harvester according to an embodiment of the present disclosure.

FIG. 8B illustrates a sectional view of the vibrational energy harvester of FIG. 8A.

FIG. 8C illustrates a top view of the vibrational energy harvester of FIG. 8A.

FIG. 9A illustrates a vibrational energy harvester according to an embodiment of the present disclosure.

FIG. 9B illustrates a sectional view of the vibrational energy harvester of FIG. 9A.

FIG. 9C illustrates a top view of the vibrational energy harvester of FIG. 9A.

FIGS. 10A-10B illustrate an exemplary technique for fabricating magnets with anti-parallel magnetization directions, according to some embodiments.

### DETAILED DESCRIPTION

Embodiments of the present disclosure comprise at least one magnetic-core solenoid, a micro-electromechanical spring system (MEMS spring), and at least one hard magnet pair. The embodiments may be manufactured by semiconductor micro-manufacturing technologies to provide a vibrational energy harvester in a chip-scale package.

Use of integrated solenoids with magnetic cores may provide higher energy density than other candidate chip-scale approaches, e.g., air-core or planar coils. The use of high permeability magnetic cores with low loss may enable high energy density of the solenoids. Die bonding skills may be used to form a magnet pair with antiparallel magnetization directions, which maximize the magnetic flux change and, by extension, the output voltage generated by the coils. The deposited magnet pair with anti-parallel directions may allow maximum magnetic flux change that induces high voltage across the solenoids. It may also introduce a non-linear oscillation effect which enables the harvester a much wider vibration bandwidth.

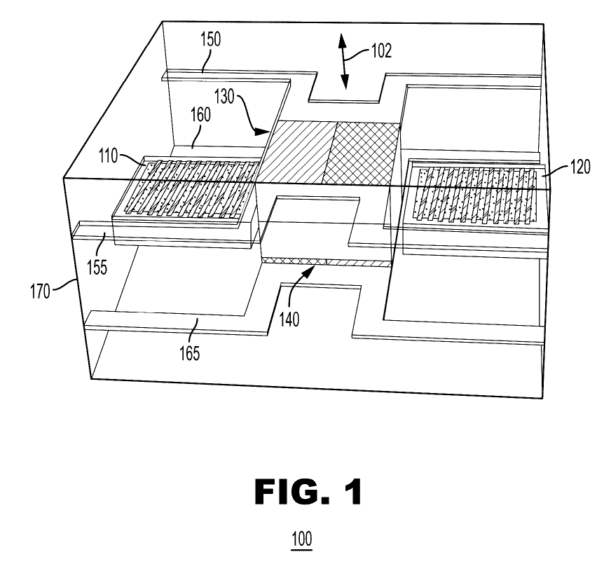

FIG. 1 illustrates a vibrational energy harvester 100 according to an embodiment of the present disclosure. FIG. 1 provides a perspective view of the harvester 100.

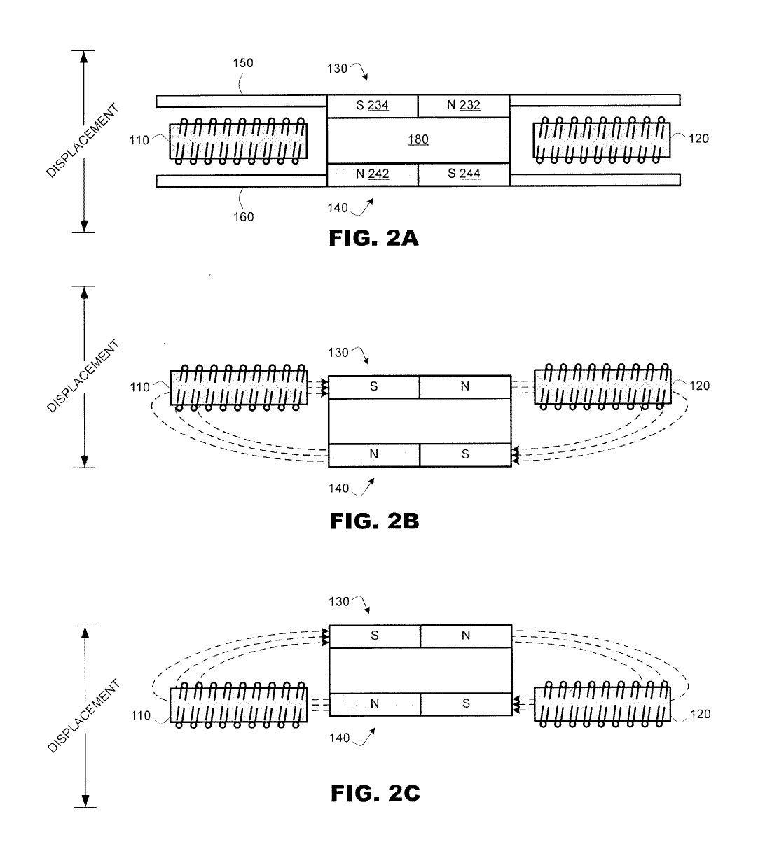

FIGS. 2A-2C illustrate sectional views of the harvester 100. FIG. 2A illustrates the harvester 100 in an equilibrium state. FIGS. 2B and 2C illustrate operational states of the harvester 100. The equilibrium state of FIG. 2A may occur when the harvester is stationary, or as it passes between the states of FIGS. 2B and 2C.

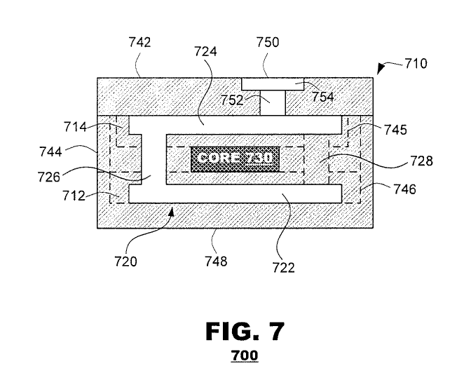

The harvester 100 may include a pair of coils 110, 120 with magnetic cores, and a pair of magnets 130, 140 provided on MEMS springs 150, 155, 160, 165. The coils 110, 120 may include a winding around a magnetic core, an example of which is described below in connection with FIG. 7. The magnets 130, 140 each include north and south poles, indicated by the different fill patterns, and identified in FIG. 2A. The MEMS springs may or may not utilize the geometry in FIG. 1, as long as they produce an oscillation along the vertical direction 102 when an external vibration is applied. In this embodiment, the coils 110, 120 may be mounted on a stationary frame 170, represented by the bounding box in FIG. 1. The magnets 130, 140 may be coupled to the frame 170 via the MEMS springs 150, 155, 160, and 165. This configuration allows vibrational energy to cause the magnets 130, 140 to move in a predetermined direction with respect to the coils 110, 120 with a predetermined range of motion (shown as “displacement” in FIGS. 2A-2C). As illustrated in FIGS. 2B and 2C, relative motion between the magnets 130, 140 and the coils 110, 120 may cause changes in the magnitude and orientation of magnetic flux that passes through the coils 110, 120, inducing variations in currents through the coils.

The harvester 100 may be fabricated using microelectronic semiconductor techniques. In one embodiment, the magnets 130, 140 may be manufactured on a first substrate using micro-manufacturing techniques, the MEMS springs 150, 155, 160, and 165 may be manufactured on a second substrate using micro-manufacturing techniques, and the coils 110, 120 may be manufactured on a third substrate, also using micro-manufacturing techniques. The second substrate may also define the stationary frame 170 in at least some embodiments. The first, second, and third substrates may be semiconducting substrates (e.g., silicon substrates), glass substrates, printed circuit boards (PCB), or other suitable substrate, and in some embodiments one or more of the substrates may be integrated circuit substrates. In some embodiments the substrates differ from each other, and in other embodiments they are the same as each other. Assembly of the harvester 100 may be completed by mounting the magnets 130, 140 and the coils 110, 120 within the frame 170 in a permanent manner. In another embodiment, the coils 110, 120, the magnets 130, 140, and the MEMS springs 150, 155, 160, and 165 all may be manufactured within a single substrate. In other embodiments, any two groups of the coils 110, 120 (group 1), the magnets 130, 140 (group 2), and the MEMS Springs 150, 155, 160, and 165 (group 3) may be manufactured within a first substrate and the remaining group may be manufactured within a second substrate.

The magnets 130, 140 may be fabricated separately and assembled with anti-parallel magnetization directions, as can be seen, for example, in FIG. 2A. Table 1 lists exemplary materials that may find application as magnets 130, 140 in the harvester 100, as well as methods that may be employed to manufacture them.

TABLE 1

| | | | FABRICATION |
|---|---|---|---|
| MATERIAL | COERCIVITY | | METHOD |
| NdFeB | 1.5- 2T | | Pulsed Laser |
| | | | Deposition |
| | 15 | kOe | Magnetron Sputtering |
| SmCo | 15.5 | kOe | Magnetron Sputtering |
| | 8.9 | kOe | Pulsed Laser |
| | | | Deposition |
| | 553 | Oe | Electroplating |
| CoCr, CoNi | 1 | kOe | Vacuum Deposition |
| CoNiMnP | 751 | Oe | Electroplating |
| Co—Pt | 10 | kOe | Electroplating |

As illustrated in FIG. 2A, the magnets 130, 140 may include respective north poles 232, 242 and south poles 234, 244. The magnets 130, 140 may be mounted on the springs 150, 155, 160, and 165 in a manner to maintain predetermined separation from each other. For example, as illustrated in FIG. 2A, the magnets 130, 140 may be provided on opposing surfaces of a substrate material 180 such as silicon. In this manner, the magnets 130, 140 define a predetermined magnetic field in a region around them.

FIGS. 2B and 2C illustrate effects of relative motion between the magnets 130, 140 and the coils 110, 120. As explained, the magnets 130, 140 are provided with a predetermined spatial distance between them, which defines a predetermined magnetic field about the north and south poles of the magnets 130, 140. FIGS. 2B and 2C, therefore, illustrate a common set of flux lines to represent this phenomenon.

FIG. 2B illustrates the magnets 130, 140 at a lowest point in the range of motion afforded by the MEMS springs (not shown in FIG. 2B), shown as the bottom of the displacement range. At this point, the coil 110 is closest to the south pole of magnet 130 and the coil 120 is closest to the north pole of magnet 130. The coils 110, 120 therefore pass flux in a predetermined orientation (shown generally as left to right in FIG. 2B). The magnetic flux that passes through these coils 110, 120 will generate currents in the coils in a first orientation.

FIG. 2C illustrates the magnets 130, 140 at a highest point in the range of motion afforded by the MEMS springs (not shown in FIG. 2C), shown as the top of the displacement range. At this point, the coil 110 is closest to the north pole of magnet 140 and the coil 120 is closest to the south pole of magnet 140. The coils 110, 120 therefore pass flux in a predetermined orientation (shown generally as right to left in FIG. 2C), which is opposite to the orientation that occurs in the FIG. 2B case. The magnetic flux that passes through these coils 110, 120 will generate currents in the coils in a second orientation. Thus, as the magnets 130, 140 oscillate within their range of motion, the flux that passes through the coils also will fluctuate and generate oscillating currents within the coils 110, 120.

FIG. 1 illustrates a system with a pair of magnets 130, 140. Although the principles of the present disclosure extend to systems that include a single magnet (say magnet 130), a dual magnet design is preferred to maximize flux intensity through the coils 110, 120 and, by extension, to maximize the energy output of the coils 110, 120.

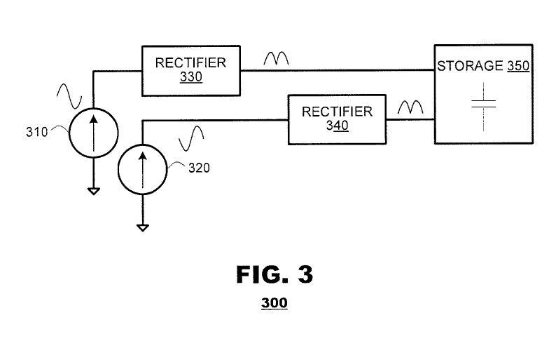

FIG. 3 depicts a block diagram of an energy harvester circuit system 300 according to an embodiment of the present disclosure. The system 300 may include the coils 310, 320, rectifiers 330, 340 and a storage circuit 350. The coils 310, 320 are illustrated as current sources to illustrate the currents that they generate based on movement of the magnets and may be, for example, the coils 110 and 120 of FIG. 1.

As illustrated, the coils 310, 320 each may output alternating currents to their respective rectifiers 330, 340. The rectifiers 330, 340 may convert the alternating currents from the coils 310, 320 to direct currents and may output those direct currents to the storage circuit 350. The storage circuit 350 may store charges from outputs of the rectifiers 330, 340 as captured energy.

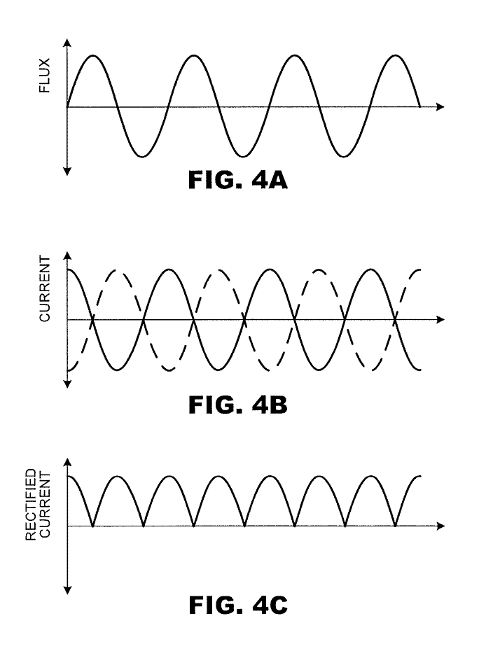

FIGS. 4A-4C illustrate exemplary waveforms showing relationships among flux passing through the coils 110, 120 of FIG. 1 (graph of FIG. 4A), current generated by the coils (graph of FIG. 4B) and rectified current generated by the rectifiers 330, 340 of FIG. 3 (graph of FIG. 4C). FIGS. 4A-4C illustrates idealized graphs without the non-linear effect from the existence of magnets; in practice the signals generated by the coils 110, 120 and, by extension, the rectifiers 330, 340 likely will vary from those illustrated in FIGS. 4A-4C.

As illustrated in FIG. 4A, the flux that passes through the coils 110, 120 (FIG. 1) may likely vary in a generally sinusoidal fashion. The varying flux may induce corresponding variations in currents generated by the coils 110, 120. Depending on orientations of windings and other operational parameters, the currents output by the coils may vary with respect to each other. For example, if windings of the coils are provided in opposing orientations, the currents generated by the two coils may be out of phase with respect to each other (shown by the solid and dashed lines in FIG. 4B). In at least some embodiments, the coils are connected in a way which increases, and in some cases maximizes, the total output voltage. FIG. 4C illustrates rectified currents that may be generated by the rectifiers 330, 340 from the currents illustrated in FIG. 4B.

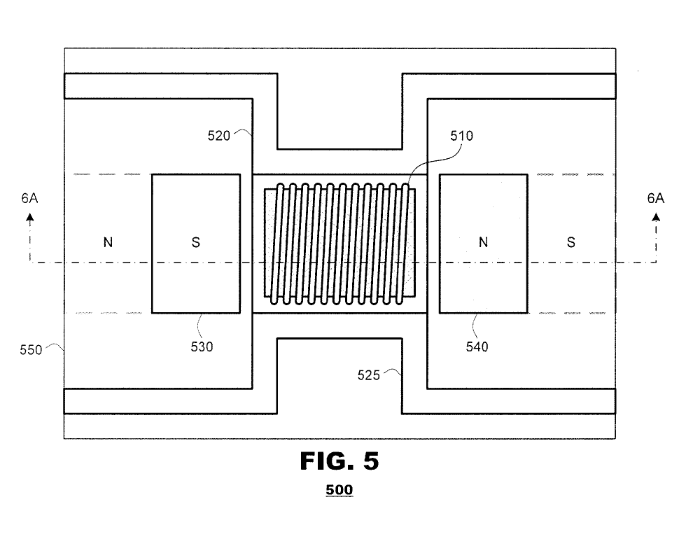

FIG. 5 illustrates a vibrational energy harvester 500 according to an embodiment of the present disclosure. FIG. 5 provides a top view of the harvester 500.

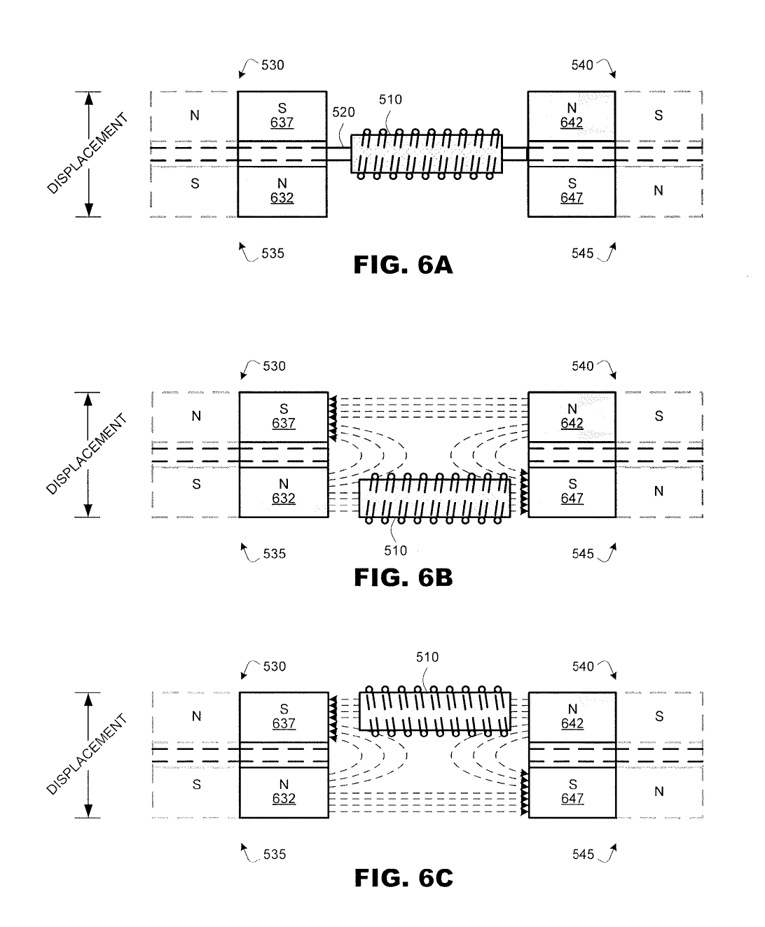

FIGS. 6A-6C illustrate sectional side views of the harvester 500. FIG. 6A illustrates the harvester 500 in an equilibrium state. FIGS. 6B and 6C illustrate operational states of the harvester 500. The equilibrium state of FIG. 6A may occur when the harvester is stationary, or as it passes between the states of FIGS. 6B and 6C.

The harvester 500 may include a coil 510 with a magnetic core mounted on a pair of MEMS springs 520, 525, and two pairs of magnets 530 and 535, 540 and 545. Magnets 535 and 545 appear in the sectional view of FIG. 6A, but are not visible in the view of FIG. 5 because they lie in a different plane than magnets 530 and 540. In this embodiment, the magnets 530, 535, 540, and 545 may be mounted on a stationary frame 550, represented by the bounding box in FIG. 5. The coil 510, which may the same type as coils 110 and 120 in some embodiments, an example being described below in connection with FIG. 7, may be coupled to the frame 550 via the MEMS springs 520, 525. This configuration allows vibrational energy to cause the coil 510 to move in a predetermined direction (e.g., into and out of the page with respect to FIG. 5) with respect to the magnets 530, 535, 540, and 545 with a predetermined range of motion (shown as “displacement” in FIGS. 6A-6C). As illustrated in FIGS. 6B and 6C, relative motion between the coil 510 and the magnets 530, 535, 540, and 545 may cause changes in the magnitude and orientation of magnetic flux that passes through the magnetic core of the coil 510, inducing variations in currents through the coil.

The energy harvester 500 may be fabricated using microelectronic semiconductor techniques. In one embodiment, the coil 510 and the MEMS springs 520, 525 may be manufactured on a first substrate using micro-manufacturing techniques and the magnets 530, 535, 540, and 545 may be manufactured separately from the MEMS springs 520, 525 also using micro-manufacturing techniques. The first substrate also would define the stationary frame 550 in at least some embodiments. Assembly of the harvester 500 may be completed by mounting the magnets 530, 535, 540, and 545 within the frame 550 in a permanent manner. In another embodiment, the coil 510, the magnets 530, 535, 540, and 545, and the MEMS springs 520, 525 all may be manufactured within a single substrate. The substrate may be any of the types described in connection with FIG. 1, such as an integrated circuit substrate, or any other suitable type.

The magnets 530, 535, 540, and 545 may be fabricated separately and assembled with anti-parallel magnetization directions. In practice, the magnets 530, 535, 540, and 545 may be fabricated on a common wafer as identical magnets, which are bonded together thereafter in paired fashion. Table 1 lists exemplary materials that may find application as magnets 530, 535, 540, and 545 in the harvester 500.

FIG. 6A illustrates respective north poles 632, 642 and south poles 637, 647 of the magnets 535, 540, 530, and 545. The magnets 530, 535, 540, and 545 may be mounted within the frame 550 in a manner to maintain predetermined separation from each other. Moreover, the poles 632 and 642, 637, 647 of the magnets 535, 540, 530, and 545, respectively, may be provided on opposing surfaces of respective substrates, such as silicon substrates. In this manner, the magnets 530, 535, 540, and 545 define a predetermined magnetic field in a region around them.

FIGS. 6B and 6C illustrate effects of relative motion between the coil 510 and the magnets 530, 535, 540, and 545. As explained, the magnets 530, 535, 540, and 545 are provided with a predetermined spatial distance between them and, thus, the poles 632, 642, 637, and 647 may define a predetermined magnetic field about the magnets 530, 535, 540, and 545. FIGS. 6B and 6C, therefore, illustrate a common set of flux lines to represent this phenomenon.

FIG. 6B illustrates the coil 510 at its lowest point in the range of motion afforded by the MEMS springs 520, 525, shown as the bottom of the displacement range. At this point, the coil 510 is between the north pole 632 of magnet 535 and the south pole 647 of magnet 545. The coil 510, therefore, passes flux in a predetermined orientation (shown generally as left to right in FIG. 6B). The magnetic flux that passes through the coil 510 generates a current in a first orientation.

FIG. 6C illustrates the coil 510 at its highest point in the range of motion afforded by the MEMS springs 520, 525, shown as the top of the displacement range. At this point, the coil 510 is between the south pole 637 of magnet 530 and the north pole 642 of magnet 540. The coil 510, therefore, passes flux in a predetermined orientation (shown generally as right to left in FIG. 6C), which is opposite to the orientation that occurs in the FIG. 6B case. The magnetic flux that passes through the coil 510 may generate a current in a second orientation. Thus, as the coil 510 oscillates within its range of motion, the flux that passes through the coil 510 also will fluctuate and generate oscillating currents within the coil 510.

The energy harvester of FIG. 5 also finds application in the circuit system 300 illustrated in FIG. 3. The coil 510 may operate as a single current source (say, source 310 in FIG. 3). In this application, there need not be a second current source 320 as illustrated in FIG. 3. Moreover, the graphs illustrated in FIGS. 4A-4C also may apply to the FIG. 5 embodiment.

FIG. 5 illustrates a system with two pairs of magnets 530 and 535, and 540 and 545. Although the principles of the present disclosure extend to systems that include a single magnet pair (say magnets 530 and 535), a dual magnet design is preferred to maximize flux intensity through the coil 510 and, by extension, to maximize the energy output of the coil 510.

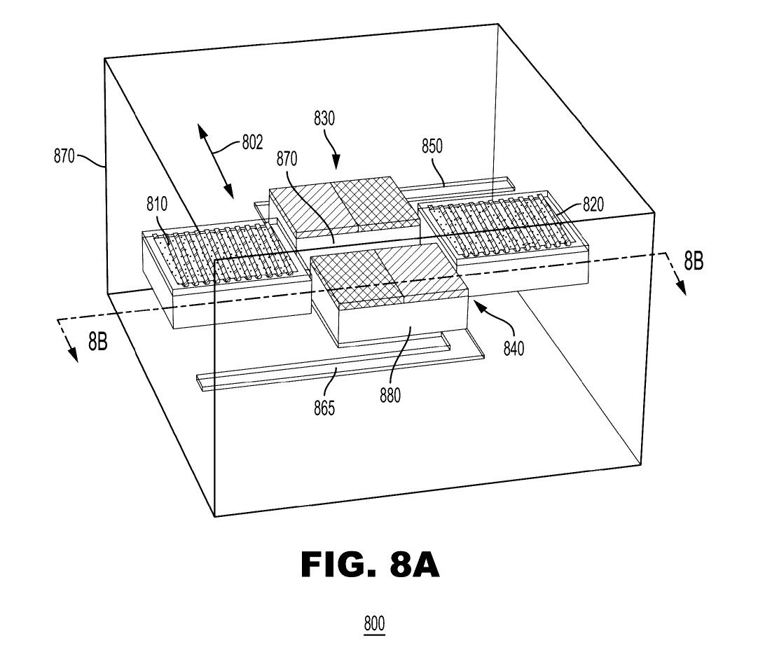

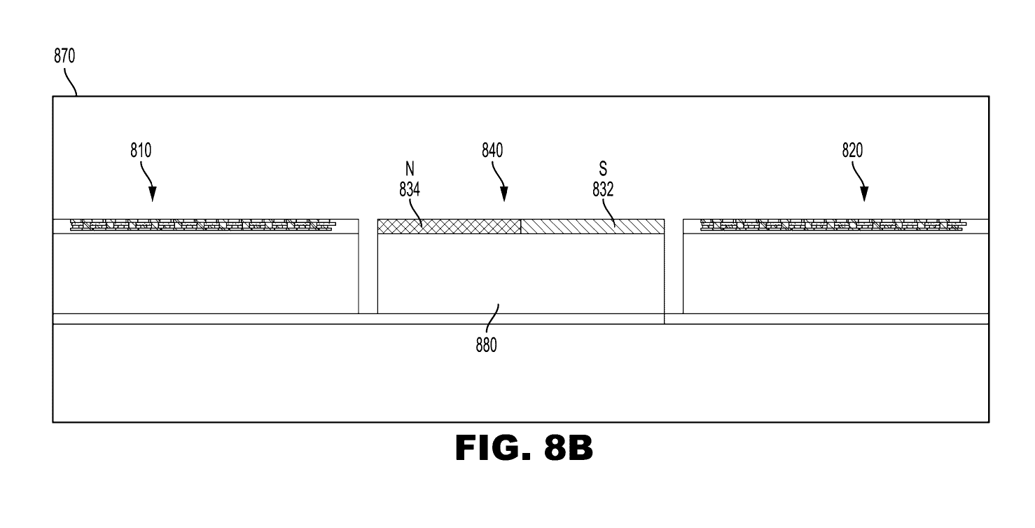

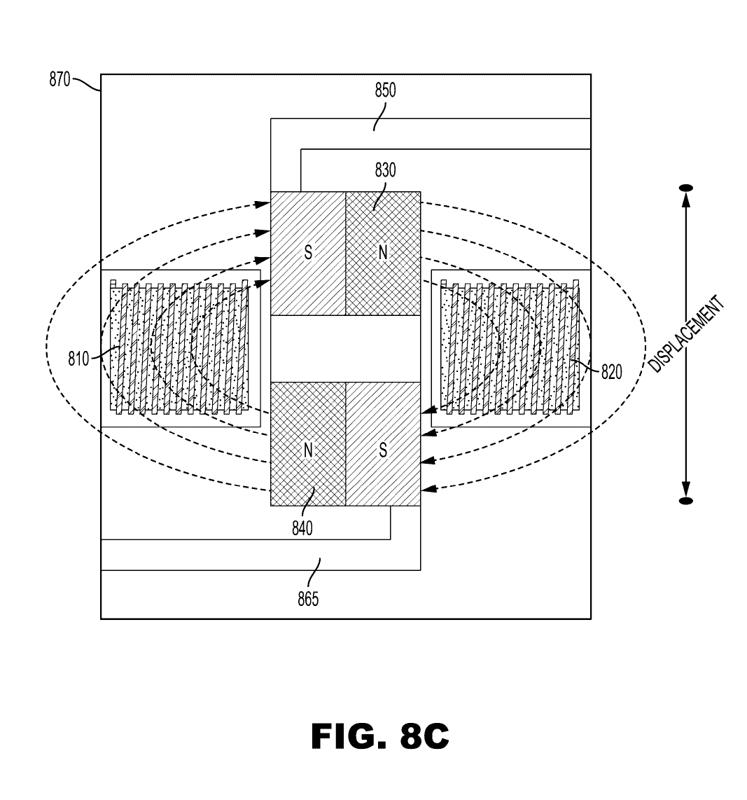

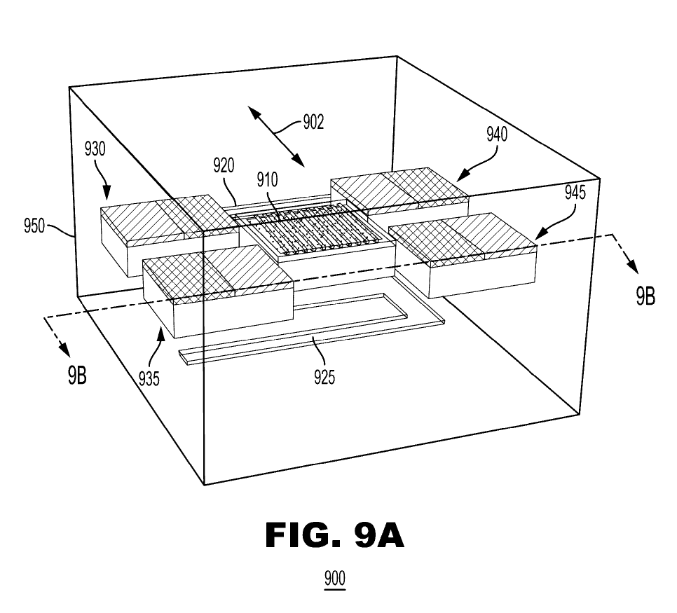

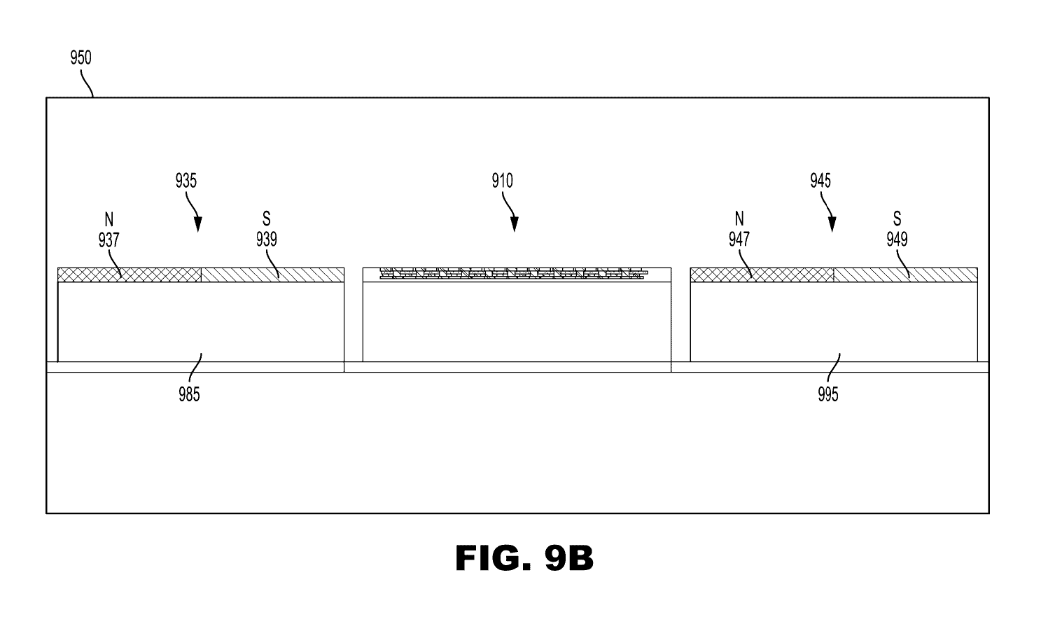

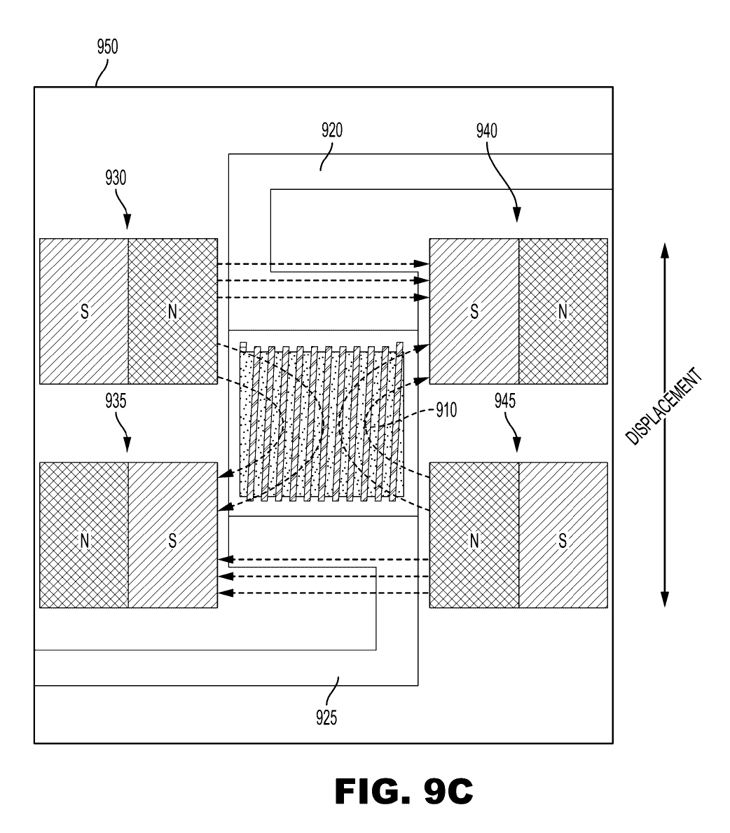

FIG. 7 illustrates a sectional view of a coil 700 with a magnetic core 730 according to an embodiment of the present disclosure. The coil 700 may find application as a coil 110, 120 as in FIG. 1 or a coil 510 as in FIG. 5. The coil 700 may also be used as coils 810 and 820 of FIG. 8A, and coil 910 of FIG. 9A, described further below. FIG. 7 is a schematic illustration only; components are not drawn to scale. As illustrated, the coil 700 may include a semiconductor structure 710 having a conductor winding 720 surrounding a magnetic core 730 over several spiral turns. The winding 720 and magnetic core 730 may be constructed over several layers of the semiconductor structure 710.

The winding 720 may be formed by building traces 722, 724 in two parallel sub-layers 712, 714 of the semiconductor structure 710, which are connected by winding posts 726, 728 extending upwardly through other sub-layers to connect to the traces 722, 724 in the sub-layers 712, 714. When the coil 700 is manufactured in an integrated circuit, the winding 720 may include several sets of posts 726, 728 and traces 722, 724 arranged in a multi-turn spiral. The coil 700 also may include a magnetic core 730 provided in a center area formed by the conductor spiral. The conductors 722, 724, 726, 728 may be encased in various layers of dielectric insulating material 742-748 to prevent electrical engagement between the magnetic core 730 and any other circuit component.

FIG. 7 further illustrates a connector 750, such as a bonding pad connector, to facilitate electrical connection between the winding 720 and other circuit elements such as a rectifier (FIG. 3). The connector 750 may include a post 752, and a pad 754. The post 752 may be formed in a via that extends through a dielectric 742 to electrically engage the winding 720. Thus, FIG. 7 illustrates the post 752 connected to a trace 724 of the winding 720. Thus, the connector 750 may provide electrical connection between the winding 720 and external circuit components.

Although FIG. 7 illustrates a connector 750 which may represent a bonding pad connector, the principles of the present disclosure accommodate other types of connections, including for example solder ball connectors.

The orientation of the magnetic core 730 and the winding 720 allows the conductors to be manufactured according to conventional integrated circuit manufacturing techniques. Using semiconductor masks and photolithography, the winding 720, dielectrics 742-748 and magnetic core 730 may be built up in multiple layers of material depositions. In one example, winding traces 722 that form a rear surface of the winding 720 may be built up in a first stage of manufacture on top of a dielectric 748 that isolate the conductors from other components of a die (not shown) in which the coil 700 of provided. Thereafter, a dielectric layer 746 may be applied to fill in interstitial regions between the traces 722 and also to cover them. In another stage, materials representing the magnetic core 530 may be laid upon the dielectric layer 746. Additionally, materials representing the winding posts 726, 728 may be built up from appropriate connection points of the rear surface traces 722 to build lateral sides of the winding 720. An additional layer 745 of dielectric material may be applied to encase the magnetic core 530 and winding posts 726, 728 in the dielectric. Further metallic material may be deposited on the dielectric-covered front side of the magnetic core 530 to build up front traces 724 to complete the winding 720. Thereafter a final layer 742 of dielectric may be deposited on the winding 720 with accommodation made for any interconnect structures 752, 754 that are needed.

In an embodiment, the dielectric materials may be high dielectric constant materials, exhibiting high resistance to electrical breakdown, such as polyimide, silicon dioxide, silicon nitride and the like. The magnetic core 530 and can be made of materials of high permeability such as CoTaZr (cobalt tantalum zirconium), NiFe (nickel ferrite), and FeCo (ferrite cobalt)-based alloys. The windings and metal interconnect structures may be formed of an appropriate conductive metal such as gold or copper.

Further, although not shown in FIG. 7, the magnets of the various embodiments described herein may be manufactured using on silicon manufacturing techniques. For example, magnetic material may be deposited on a silicon substrate of desired width and segmented into portions. Two portions may be joined together at their silicon surfaces to form magnets as illustrated in FIGS. 1 and 5, separated by a distance corresponding to twice the thickness of the substrate. Additionally, the MEMS springs of the foregoing embodiments may be fabricated using on silicon techniques.

Harvesters 100 and 500 are configured to harvest energy in response to vibrations occurring along the vertical direction, as illustrated in FIGS. 2A-2C and 6A-6C respectively. Alternatively, or additionally, vibrational energy harvesters in accordance with aspects of the present disclosure may be configured to harvest energy in response to vibrations occurring along a direction other than the vertical direction. FIG. 8A-8C illustrate an exemplary harvester 800 configured to harvest vibrational energy in response to vibrations along a horizontal direction 802.

FIG. 8A illustrates a vibrational energy harvester according to an embodiment of the present disclosure. FIG. 8A provides a perspective view of the harvester 800.

The harvester 800 may include a pair of coils 810, 820 with magnetic cores, and a pair of magnets 830, 840 provided on MEMS springs 850 and 865. The magnets 830, 840 may have oppositely oriented poles relative to each other, as can be seen in FIG. 8C, described below. The different poles of magnets 830 and 840 are indicated in FIG. 8A by the different fill patterns. The MEMS springs 850 and 865 may or may not utilize the geometry in FIG. 8A, as long as they produce an oscillation along the horizontal direction 802 when an external vibration is applied. In this embodiment, the coils 810, 820 may be mounted on a stationary frame 870, represented by the bounding box in FIG. 8A. The magnets 830, 840 may be coupled to the frame 870 via the MEMS springs 850, 865. This configuration allows vibrational energy to cause the magnets 830, 840 to move in a predetermined direction with respect to the coils 810, 820 with a predetermined range of motion. Relative motion between the magnets 830, 840 and the coils 810, 820 may cause changes in the magnitude and orientation of magnetic flux that passes through the coils 810, 820, inducing variations in currents through the coils, as can be appreciated from the view of FIG. 8C. The harvester 800 may be fabricated using the techniques described in connection with FIG. 1.

FIG. 8B illustrates a sectional view of the harvester 800 taken along the line 8B-8B. The magnets 830, 840 may include respective north poles and south poles. For example, the magnet 840 may include north pole 834 and south pole 832. The magnets 830, 840 may be mounted on the springs 850, 865 in a manner to maintain predetermined separation from each other. For example, as illustrated in FIG. 8A, the magnets 830, 840 may be disposed on substrates 870, 880 respectively. The substrates may include silicon, or any of the other types described in connection with FIG. 1. In this manner, the magnets 830, 840 define a predetermined magnetic field in a region around them. The magnets 830, 840 may be fabricated separately or in combination, and may be assembled with anti-parallel magnetization directions. The magnets 830, 840 may include any suitable combination of the materials listed in Table 1, or any other suitable materials. Coils 810 and 820 may be implemented using coil 700 of FIG. 7, as a non-limiting example.

FIG. 8C illustrates a top view of the harvester 800. As illustrated, the magnets 830, 840 may be assembled with anti-parallel magnetization directions. As explained, the magnets 830, 840 are provided with a predetermined spatial distance between them, which defines a predetermined magnetic field about the north and south poles of the magnets 830, 840. FIG. 8C illustrates an exemplary set of flux lines to represent this phenomenon. However, the magnetic field may not be limited to the flux lines illustrated.

In some embodiments, the magnets 830, 840 may be rigidly connected and may be configured to vibrate as a unitary body. In other embodiments, the magnets 830, 840 may be free to move independently. In either circumstances, the coils 810, 820 may experience a flux passing therethrough having a first or a second orientation depending on the relative position of the magnets with respect to the coils. For example, the coil 810 may experience a flux having a first orientation when it is closer to the south pole of magnet 830 than the north pole of magnet 840. Contrarily, the coil 810 may experience a flux having a second orientation, opposite the first orientation, when it is closer to the north pole of magnet 840 than the south pole of magnet 830. The magnetic flux that passes through these coils will generate currents in the coils in a first orientation in the first case, and a second orientation in the second case. Thus, as the magnets 830, 840 oscillate within their range of motion, the flux that passes through the coils also will fluctuate and generate oscillating currents within the coils 810, 820.

FIG. 8A-8C illustrate a system with a pair of magnets 830, 840. Although the principles of the present disclosure extend to systems that include a single magnet (say magnet 830), a dual magnet design is preferred to maximize flux intensity through the coils 810, 820 and, by extension, to maximize the energy output of the coils 810, 820. However, the application is not limited in this respect and any suitable number of magnets may be used.

The harvester 800 may be implemented within energy harvester circuit system 300. Coils 810, 820 may serve as coils 310, 320. In response to the flux illustrated in FIG. 4A, the coils may be configured to generate currents according to FIG. 4B, which may be rectified by rectifiers 330, 340 to produce the currents illustrated in FIG. 4C.

FIG. 9A illustrates a vibrational energy harvester according to an embodiment of the present disclosure. FIG. 9A provides a perspective view of the harvester 900.

The harvester 900 may include a coil 910 with a magnetic core mounted on a pair of MEMS springs 920, 925, and two pairs of magnets 930 and 935, 940 and 945. The magnets 930, 935, 940, and 945 may have north and south poles, indicated in FIG. 9A by the presence of two different fill patterns for each of 930, 935, 940, and 945. In this embodiment, the magnets 930, 935, 940, and 945 may be mounted on a stationary frame 950, represented by the bounding box in FIG. 9A. The coil 910 may be coupled to the frame 950 via the MEMS springs 920, 925. This configuration allows vibrational energy to cause the coil 910 to move in a predetermined direction 902 with respect to the magnets 930, 935, 940, and 945 with a predetermined range of motion. Relative motion between the coil 910 and the magnets 930, 935, 940, and 945 may cause changes in the magnitude and orientation of magnetic flux that passes through the magnetic core of the coil 910, inducing variations in currents through the coils. The harvester 800 may be fabricated using the techniques described in connection with FIG. 5.

The magnets 930, 935 may be fabricated separately and assembled with anti-parallel magnetization directions. Similarly, The magnets 940, 945 may be fabricated separately and assembled with anti-parallel magnetization directions. In practice, the magnets 930, 935, 940, and 945 may be fabricated on a common wafer as identical, or substantially identical, magnets, which are bonded together thereafter in paired fashion. Table 1 lists exemplary materials that may find application as magnets 930, 935, 940, and 945 in the harvester 900. Coil 910 may be implemented using coil 700 of FIG. 7.

FIG. 9B illustrates a sectional view of the harvester 900 taken along line 9B-9B. As illustrated, the magnet 935 may be disposed on a substrate 985, such as a silicon substrate, and may include a north pole 937 and a south pole 939. The magnet 945 may be disposed on a substrate 995, such as a silicon substrate, and may include a north pole 947 and a south pole 949. The magnets may be assembled to generate a magnetic flux directed from north pole 947 to south pole 939. The substrates 985 and 995 may be any of the types described in connection with FIG. 1.

FIG. 9C illustrates a top view of the harvester 900. As illustrated, the magnets 930, 935, and the magnets 940, 945 may be assembled with anti-parallel magnetization directions. The magnets may be provided with a predetermined spatial distance between them, which defines a predetermined magnetic field about the north and south poles of the magnets 930, 935, 940, 945. FIG. 9C illustrates an exemplary set of flux lines to represent this phenomenon. However, the magnetic field may not be limited to the flux lines illustrated.

The coil 910 may be configured to oscillate in response to vibrations occurring in a horizontal direction shown in FIG. 9C. When it is between the north pole of magnet 930 and the south pole of magnet 940, the coil 910 may experience a flux passing therethrough in a first orientation (shown generally as left to right in FIG. 9C). The magnetic flux that passes through the coil 910 generates a current in the coil in a first orientation.

Contrarily, when the coil 910 is between the north pole of magnet 945 and the south pole of magnet 935, it may experience a flux passing therethrough in a second orientation (shown generally as right to left in FIG. 9C). The magnetic flux that passes through the coils 910 generates a current in the coil in a second orientation, opposite the first orientation. Thus, as the coil 910 oscillates within its range of motion, the flux that passes through the coil 910 also will fluctuate and generate oscillating currents within the coil 910.

The energy harvester of FIGS. 9A-9C may be implemented within the circuit system 300 illustrated in FIG. 3. The coil 910 may operate as a single current source (say, source 310 in FIG. 3). In this application, there need not be a second current source 320 as illustrated in FIG. 3. Moreover, the graphs illustrated in FIGS. 4A-4C also may apply to the FIG. 9A-9C embodiment.

FIG. 9A-9C illustrate a system with two pairs of magnets 930 and 935, and 940 and 945. Although the principles of the present disclosure extend to systems that include a single magnet pair (say magnets 930 and 935), a dual magnet design is preferred to maximize flux intensity through the coil 910 and, by extension, to maximize the energy output of the coil 910. However, the application is not limited in this respect and any suitable number of magnets may be used.

The harvesters 100, 500, 800 and 900 may be used individually or in any suitable combination. In certain circumstances vibrations occurring along more than one orientation may be expected. In such circumstances, one or more harvesters configured to harvest energy in response to vibrations occurring along the vertical direction, such as harvester 100 or 500, may be used in combination with one or more harvesters configured to harvest energy in response to vibrations occurring along the horizontal direction, such as harvester 800 or 900.

The harvesters 100, 500, 800 and 900 may be manufactured by semiconductor micro-manufacturing technologies to provide a vibrational energy harvester in a chip-scale package. In some embodiments, such harvesters may be packaged, and pressure within the package may be reduced with respect to the external pressure. In some embodiments, vacuum in the package may be obtained, which may reduce damping and increase output power.

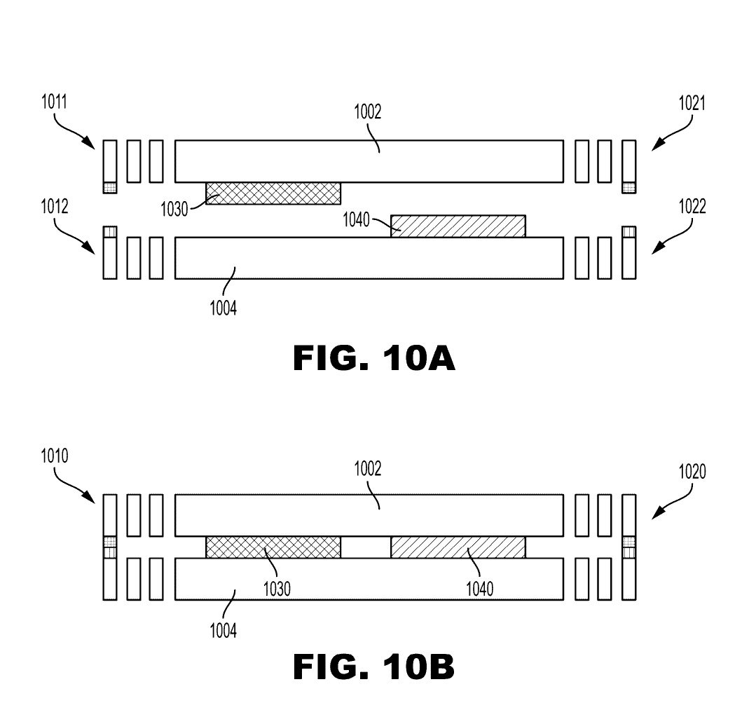

Pairs of magnets having anti-parallel magnetization directions may be fabricated using a pair of substrates. FIG. 10A-10B illustrate an exemplary technique for fabricating magnets with anti-parallel magnetization directions, according to some embodiments. As illustrated in FIG. 10A, a magnet 1030 may be disposed on a surface of a substrate 1002, and a magnet 1040 may be disposed on a surface of a substrate 1004. The magnets 1030 and 1040 may serve as any of the magnet pairs described in connection with harvesters 100, 500, 800 and 900. Substrate 1002 may include spring elements 1011 and 1021, which may be located on opposite sides with respect to magnet 1030. Substrate 1004 may include spring elements 1012 and 1022, which may be located on opposite sides with respect to magnet 1040.

As illustrated in FIG. 10B, substrate 1002 may be bonded to substrate 1004. Bonding of the substrates may be performed using any suitable bonding technique. Once the substrates are bonded, magnets 1030 and 1040 may be located in proximity to one another and may have anti-parallel magnetization directions. In some embodiments, substrate 1002 and/or substrate 1004 may be removed following the bonding procedure. Once the substrates are bonded, spring element 1011 may be connected to spring element 1012 thus forming MEMS spring 1010, and spring element 1021 may be connected to spring element 1022 thus forming MEMS spring 1020. MEMS springs 1010 and 1020 may serve as any of the MEMS sprigs described in connection with harvesters 100, 500, 800 and 900.

The vibrational energy harvesters described herein may find application in health monitoring for industrial machines. For example, a system for monitoring the health of a machine may be mounted on a shaft, a rotor, or any suitable mechanical part of the machine. Such system may include one or more sensors, such as linear and/or angular accelerometers, and may be configured to monitor the condition of the machine. The system may further include a vibrational energy harvester of the type described herein configured to harvest energy in response to vibrations of the part of the machine on which the system is mounted. The harvester may be connected to an energy storage device, such as a battery or a capacitor. For example, storage circuit 350 of FIG. 3 may be used. In some embodiments, the system may further include a communication interface, such as an antenna, configured to transmit the data obtained from the one or more sensors to a monitoring station, such as a computer. Power to the system, including power for the sensor, may be provided, at least in part, through the energy harvested by the vibrational energy harvester.

The vibrational energy harvesters described herein may find application in engines for vehicles or aircrafts. For example, an energy harvester may be mounted on a shaft, a belt, a fan, or any suitable mechanical part of an engine. The harvester may be connected to an energy storage device, such as a battery or a capacitor (e.g., storage circuit 350), and may be configured to power, at least in part, any suitable system or component of the engine.

The vibrational energy harvesters described herein may find application in heating, ventilation, and air conditioning (HVAC) systems. For example, a harvester may be mounted within, or in proximity of a duct having air, or a fluid, passing therethrough. As the air or the fluid passes through the duct, the duct may vibrate. The harvester may be configured to harvest energy in response to such vibrations. The harvested energy may be used to power a component of the system, such as a controller controlling the HVAC system, a sensor sensing operation of the HVAC system, or may be supplied to a component external to the system.

The vibrational energy harvesters described herein may find application in infrastructures. For example, a harvester may be mounted on a bridge or a building. As the bridge, or building, vibrates, for example in response to wind, the harvester may be configured to harvest vibrational energy. The harvested energy may be used to power a sensor on the structure, or may be supplied to a component remote from the structure.

Several embodiments of the disclosure are specifically illustrated and/or described herein. However, it will be appreciated that modifications and variations of the disclosure are covered by the above teachings and within the purview of the appended claims without departing from the spirit and intended scope of the disclosure. Further variations are permissible that are consistent with the principles described above.

What is claimed is:

1. An apparatus, comprising:
a coil system;
a magnet system defining a magnetic flux; and
a micro-electromechanical spring system (MEMS spring) that, in response to vibrational energy, changes a relative position between the coil system and the magnet system such that, at a first position, the magnetic flux is oriented in a first direction through the coil system and, at a second position, the magnetic flux is oriented in a second direction through the coil system.

2. The apparatus of claim 1, wherein
the magnet system is coupled to a stationary frame, and
the MEMS spring couples the coil system to the stationary frame.

3. The apparatus of claim 1, wherein
the coil system is coupled to a stationary frame, and
the MEMS spring couples the magnet system to the stationary frame.

4. The apparatus of claim 1, wherein the coil system includes at least one coil comprising a winding around a magnetic core.

5. The apparatus of claim 4, wherein the coil system is disposed on a semiconductor substrate.

6. The apparatus of claim 1, wherein the magnet system includes a first magnet with a first magnetization oriented in a first direction and a second magnet with a second magnetization oriented in a second direction anti-parallel with the first direction.

7. The apparatus of claim 6, wherein the first magnet is disposed on a first substrate and the second magnet is disposed on a second substrate.

8. The apparatus of claim 1, wherein the coil system, the magnet system, and the MEMS spring are fabricated on one substrate.

9. The apparatus of claim 1, wherein the coil system and the MEMS spring are fabricated on a first substrate and the magnet system is fabricated on a second substrate.

10. The apparatus of claim 1, wherein the magnet system and the MEMS spring are fabricated on a first substrate and the coil system is fabricated on a second substrate.

11. A method, comprising:
providing a magnetic flux via a magnet system; and
changing, in response to vibrational energy, a relative position between a coil system and the magnet system using a micro-electromechanical spring system (MEMS spring), such that, at a first position, the magnetic flux is oriented in a first direction through the coil system and, at a second position, the magnetic flux is oriented in a second direction through the coil system.

12. The method of claim 11, wherein
the magnet system is coupled to a stationary frame, and
the MEMS spring couples the coil system to the stationary frame.

13. The method of claim 11, wherein
the coil system is coupled to a stationary frame, and
the MEMS spring couples the magnet system to the stationary frame.

14. The method of claim 11, wherein the coil system includes at least one coil comprising a winding around a magnetic core.

15. The method of claim 11, wherein the magnet system includes a first magnet with a first magnetization oriented in a first direction and a second magnet with a second magnetization oriented in a second direction anti-parallel with the first direction.

16. The method of claim 15, wherein the first magnet is disposed on a first substrate and the second magnet is disposed on a second substrate.

17. The method of claim 11, wherein the coil system, the magnet system, and the MEMS spring are fabricated on one substrate.

18. The method of claim 11, wherein the coil system and the MEMS spring are fabricated on a first substrate and the magnet system is fabricated on a second substrate.

19. The method of claim 11, wherein the magnet system and the MEMS spring are fabricated on a first substrate and the coil system is fabricated on a second substrate.

20. A system, comprising:
an energy harvester;
a storage circuit; and
a rectifier circuit coupling the energy harvester to the storage circuit,
wherein the energy harvester includes:
a coil system,
a magnet system defining a magnetic flux,
a micro-electromechanical spring system (MEMS spring) that, in response to vibrational energy, changes a relative position between the coil system and the magnet system such that, at a first position, the magnetic flux is oriented in a first direction through the coil system and, at a second position, the magnetic flux is oriented in a second direction through the coil system, and
wherein the rectifier circuit is configured to rectify an alternating current from the coil system and store energy from the coil system in the storage circuit.
